(19) United States
(12) Patent Application Publication
(10) Pub. No.: US 2009/0282342 A1
(43) Pub. Date: Nov. 12, 2009

(54) System and method for travel plan monitoring and notification

(75) Inventors: Andres Fabris, Dallas, TX (US); Andrew Chen, Dallas, TX (US)

Correspondence Address: DOCKET CLERK, P.O. DRAWER 800889, DALLAS, TX, 75380, US

(73) Assignee: TRAXO, LLC, Dallas, TX (US)

(21) Appl. No.: 12/387,694

(22) Filed: May 6, 2009

Related U.S. Application Data
(60) Provisional application No. 61/051,257, filed on May 7, 2008.

(51) Int. Cl. G06F 15/16; G06F 17/30; G06F 3/01

(52) U.S. Cl. 715/733; 707/104.1; 709/206; 707/E17.044

(57) ABSTRACT

A system and method are provided that include accessing an online data source, obtaining first travel information relating to a reservation made by a user, and storing the first travel information. The method also includes obtaining and storing second travel information relating to a second reservation made by the user. The method further includes determining and storing trip information from the first and second travel information. The trip information relates to a trip planned by the user and the trip is associated with the first and second reservations. The method may include accessing the online data source repeatedly at a programmable interval.

### CROSS-REFERENCE TO RELATED APPLICATIONS

This application claims priority under 35 U.S.C. §119(e) to U.S. Provisional Patent Application No. 61/051,257 filed on May 7, 2008, which is hereby incorporated by reference.

### TECHNICAL FIELD

This disclosure relates generally to an online social network and more specifically to a system and method for automatically alerting others in an online social network of travel plans booked online or offline by a user.

### BACKGROUND

Traditionally, a traveler may notify his or her friends or acquaintances of upcoming travel plans by speaking to the person on the phone or in person, by writing to the person in an email or a letter, by posting information about the trip on a personal web page or a social networking page, or by some other communication technique. In these cases, the traveler marshals some or all of the information regarding this trip, may select persons to communicate information regarding this trip to, and takes some action to communicate the information to the selected persons.

### SUMMARY

This disclosure provides a system and method for automatically organizing and communicating a person's travel plans to selected friends and acquaintances in an extended social network.

In one embodiment, a method includes a data processing system accessing an online data source, obtaining first travel information relating to a reservation made by a user, and storing the first travel information. The method also includes the data processing system obtaining and storing second travel information relating to a second reservation made by the user. The method further includes the data processing system determining and storing trip information from the first and second travel information. The trip information relates to a trip planned by the user and the trip is associated with the first and second reservations. The method may include accessing the online data source repeatedly at a programmable interval.

In another embodiment, a method includes a data processing system storing information relating to first and second users, the first and second users associated with a third user. The method also includes the data processing system obtaining the first trip information relating to a first trip planned by the first user, the first trip information including a first destination and a first date range. The method further includes the data processing system obtaining second trip information relating to a second trip planned by the second user, the second trip information including a second destination and a second date range The method also includes the data processing system, responsive to detecting that the first and second destinations are the same and the first date range overlaps the second date range, communicating to the third user an identity of the first user, an identify of the second user, the first destination, and one or more dates within the overlap of the first date range and the second date range.

In yet another embodiment, a system includes a computer readable storage medium coupled to a processor. The processor is operable to read instructions from the computer readable storage medium to access an online data source, obtain first travel information relating to a reservation made by a user, and store the first travel information in the computer readable storage medium. The processor is also operable to read instructions to obtain and store second travel information relating to a second reservation made by the user. The processor is further operable to read instructions to determine and store trip information from the first and second travel information. The trip information relates to a trip planned by the user and the trip is associated with the first and second reservations.

In a still further embodiment, a computer program product tangibly embodied in a computer readable storage medium includes instructions for accessing an online data source, obtaining first travel information relating to a reservation made by a user, and storing the first travel information. The computer program product also includes instructions for obtaining and storing second travel information relating to a second reservation made by the user. The computer program product further includes instructions for determining and storing trip information from the first and second travel information. The trip information relates to a trip planned by the user and the trip is associated with the first and second reservations.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 presents a block diagram of a system according to the present disclosure;

FIG. 2 is a block diagram of another system in accordance with the present disclosure;

FIG. 3 presents a flow chart of actions performed by a travel data harvester in accordance with the present disclosure;

FIG. 4 presents a flow chart of actions performed by a trip builder in accordance with the present disclosure;

FIG. 5 presents a flow chart of actions performed by user and buddy functions or by third party tools in accordance with the present disclosure;

FIG. 6 presents a flow chart of actions performed by a rules engine in accordance with the present disclosure;

FIG. 7 presents a flow chart of actions performed by a notification engine in accordance with the present disclosure;

FIG. 8 presents a flow chart of actions performed by a website interface in accordance with the present disclosure;

FIG. 9 presents a flow chart of actions performed by third party tools in accordance with the present disclosure; and

FIG. 10 illustrates a data processing system in accordance with the present disclosure.

### DETAILED DESCRIPTION

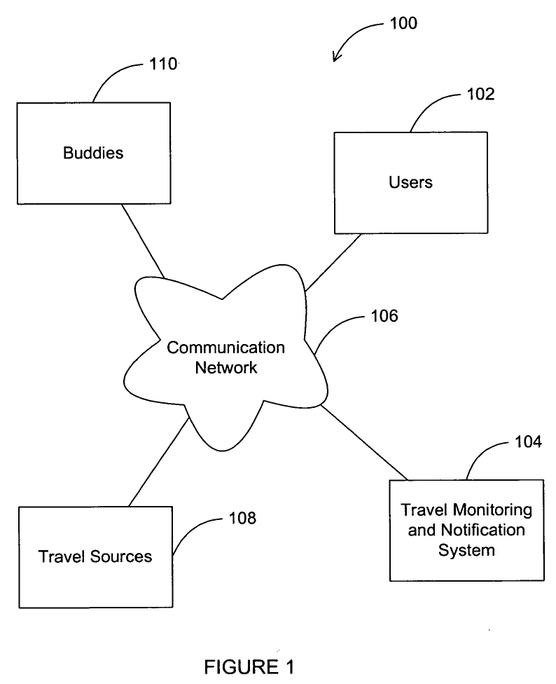

FIGS. 1 through 10, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

The present disclosure provides a system and method for communicating a person's travel plans to selected friends, family, acquaintances, acquaintances of acquaintances, and others in an extended social network. The system automatically extracts travel plans. Extraction may occur from any of multiple sources, including but not limited to: (i) popular online travel booking sites, e-mail travel confirmations, Global Distribution Systems (GDSs) such as Sabre, Galileo, Amadeus, one or several, travel agency or supplier systems, where travel was booked by or for the user, (ii) desktop travel itinerary search tools, or (iii) offline/brick-and-mortar travel agencies (each may be referred to herein as a “Travel Source”).

Raw travel data that is extracted from one or more Travel Sources may then be parsed, standardized and aggregated into discrete trips that may be approved, modified and shared by the user. Members of the user's social network may automatically receive notifications based on one or more of a number of predefined trigger events. Examples of such trigger events include:
a friend has booked a new trip
a friend will be in the same place at the same time as the user
multiple friends of a user will be in the same place at the same time

Unlike other solutions, the system of the present disclosure bypasses the need for users to manually enter or self report travel plans. Instead, users (as an upfront, one-time event) link the system to travel sites where they regularly book travel. The system then automatically “listens” in the background to detect new travel bookings made by the user.

FIG. 1 presents a block diagram of a system 100 according to the present disclosure. Users 102 are clients of a travel monitoring and notification system 104, and communicate with the system 104 via a communication network 106. The communication network 106 may be the internet, a cellular network, or other suitable public or private network for linking multiple parties for communication.

The travel monitoring and notification system 104 communicates with travel sources 108 to obtain, pull, receive, push, or distribute data regarding travel plans and reservations made by individual users 102. The system 104 processes the travel plan data and, in a manner approved by the individual user 102, communicates information about the user's historical or future travel plans to one or more so-called “buddies” 110 that have been previously or are subsequently identified by the user 102. The system 104 may also process travel plan data and make such processed data about the travel plans of an individual buddy 110 available back to Travel Sources 108. Knowledge by the user 102 of the travel plans of the buddy 110 may assist the user 102 with choosing a travel itinerary, flight, seat, hotel, activity, golf course, etc. based upon the travel plans.

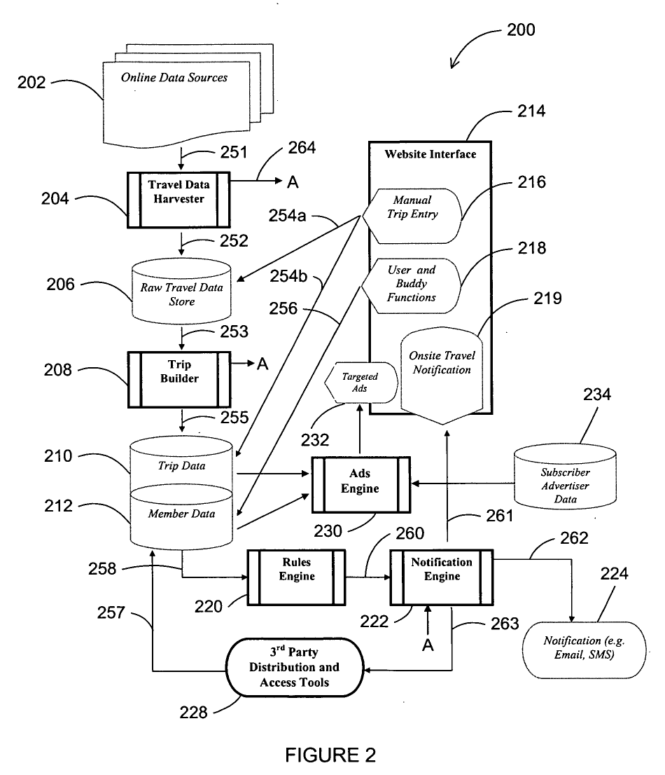

FIG. 2 is a block diagram of a system 200 in accordance with the present disclosure. The system 200 includes 7 processing components, whose operation will be described in detail below.

A travel data harvester 204 extracts travel information from third party travel websites and/or other online travel data sources 202. Such online data sources 202 may be accessed through an HTML interface or through application program interfaces (APIs), web services, applets, and portable applications provided by the online data source 202. The travel data harvester 204 may also have such travel information “pushed” to it or be notified of such travel information by other methods. The travel data harvester 204 stores such travel information into a raw travel data store 206.

A trip builder 208 standardizes and aggregates the data in the raw travel data store 206 to generate data on individual trips that are stored in a trip database 210. A rules engine 220 monitors data in the trip database 210 and in a member database 212 for predetermined trigger events. When trigger events are detected, a notification engine 222 sends system alerts to the users 102 and notifications to the users 102 and the buddies 110.

A website interface 214 provides a secured Website where the user 102 can sign up for service, view notifications, manage trips, view targeted ads, interact with other users, and manage settings and preferences. Third party tools 228 provide distribution and access tools for third parties, such as application program interfaces (APIs), web services, applets, feeds, and portable applications allow data from the system 200 to be read and written by third party applications and Websites. An ads engine 230 reviews data in the trip database 210 and the member database 212 and selects ads from subscribing advertisers to display to a user when the user is logged into the web interface 214.

Data flows in FIG. 2 include travel information 251 that is polled by or pushed to the travel data harvester 204 from one or more of third party websites 202. The travel data harvester 204 stores raw travel data 252 in a raw travel data store 206. Users may manually input raw travel data 254a to the raw travel data store 206 via the website interface 214.

The trip builder 208 reads data 253 from the raw travel data store 206 and generates trip data 255 for storage in the trip database 210. Users may manually input trip data 254b to the trip database 210 via the website interface 214.

Via the website interface 214, users also input and change data and perform other functions on user and buddy information in the member database 212. Examples of such activities include creating a new account, forming buddy connections, and updating user account information. Buddy connections may include “buddies,” who are also registered users of the system 200, as well as “friends,” who are not registered users. Examples of user account information stored in a member record of a user are the user's location of residence (“hometown”) and locations or activities for which the user is a self-professed “expert.”

Third parties use the third party tools 228 to input data 257 into the trip database 210 and/or the member database 212. The notification engine 222 may send a notification or other message 263 to a third party application via the third party tools 228.

The rules engine 220 reads data 258 from the trip database 210 and the member database 212 to detect, respectively, trip-related or buddy- or user-related trigger events. The rules engine 220 sends trigger event message 260 to the notification engine 222, which determines required alerts and notifications to be sent. Such alerts and notifications may be sent to the website interface via data flow 261. Such alerts and notifications may also be sent via e-mail, short message service (SMS) or multimedia messaging service (MMS) protocols on mobile phones, a publish/subscribe servise such as Really Simple Syndication (RSS) or Twitter, an automated phone call, or other user-selected communication channel 224 via data flow 262. Such alerts and notifications may also be posted via data flow 263 to a third party application or website via third party tools 228. Messages sent via third party tools 228 may include messages on Facebook pages, “tweets” via Twitter, and social network news stories, feeds or “lifestream” items, where a lifestream is an online record of a person's daily activities, either via direct video feed or via aggregating the person's online content such as blog posts, social network updates, and online photos.

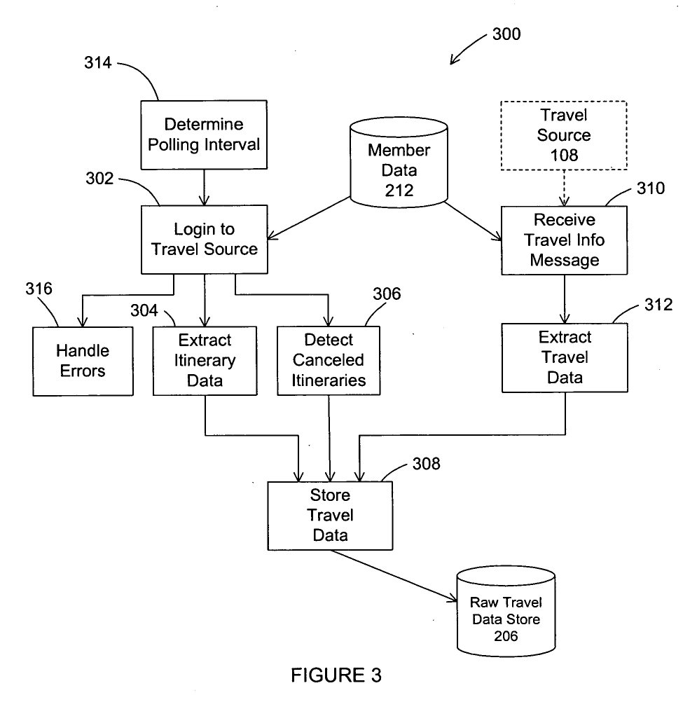

FIG. 3 presents a flow chart 300 of actions performed by the travel data harvester 204. In step 302, the travel data harvester 204 utilizes user-provided login credentials to authenticate and log into an account of a user 102 at one or more of the third party travel sources 108, such as a website or other public or private network server. The user 102 provides the login credentials for the travel sources 108 at which automatic travel data harvesting is desired and the credentials are stored in the member database 212.

Examples of such third party travel sources 108 are online travel agency websites such as American Express Travel, Expedia, Orbitz, and Travelocity; airline websites such as American Airlines, British Airways, Lufthansa, and Ryanair; hotel websites such as Best Western, Four Seasons, Hilton, and Sheraton; and car rental websites such as Avis, Enterprise Rent-A-Car, Hertz, and National. It will be understood that the travel data harvester 204 may log on to other travel-related websites as well, such as cruise lines, train service, boat charters and others.

Once logged on to the travel source 108, in step 304, the travel data harvester 204 extracts booked and confirmed itineraries and itineraries on hold for the user 102. In step 306, the travel data harvester 204 also detects cancelled itineraries or other changed information in the travel source 108 that is associated with the user 102. In step 308, the travel data harvester 204 stores the extracted and detected raw travel data 252 as records in the raw travel data store 206.

In step 310, the travel data harvester 204 receives travel information that is “pushed” to it by a travel source 108 via a communication channel such as email, HTTP POST method, or HTTP GET method. Such travel information may be detected by a desktop tool such as a web browser plug-in that detects travel information in browser activity of the user 102. Such travel information may be sent by a brick-and-mortar travel agency when the user 102 is at the agency scheduling travel with the assistance of a travel agent.

Travel information pushed to the travel data harvester 204 may be sent to an address associated with the user 102, or information within the message may identify the user 102 by email address or other identifier. In step 312, the travel data harvester 204 extracts raw travel data 252 from the message and, in step 308, stores it as records in the raw travel data store 206.

Examples of raw travel data that the travel data harvester 204 may extract from websites or messages related to air travel include airline identifier, flight number, seat number, price, origination city, destination city, departure data and time, and arrival date and time. Such information may be extracted for each leg (or segment) of a multi-stop journey. Examples of raw travel data that the travel data harvester 204 may extract from websites or messages related to car rentals include car rental company identifier, pick up city, drop off city, pick up date and time, and drop off date and time. It will be understood that similar information may be extracted from reservations for other types of transportation providers, such as ferries, trains, RV rentals, boat charters and motorcycle rentals.

Examples of raw travel data that the travel data harvester 204 may extract from websites or messages related to hotels include hotel name, hotel chain identifier, location, check in date, and check out date. Examples of raw travel data that the travel data harvester 204 may extract from websites or messages related to other destination activities include location, and activity time (e.g., tee time or restaurant reservation time). It will be understood that similar information may be extracted from reservations for other types of destination providers, such as cruise ships, camps, lodges and co-ops.

The user 102 may use a manual trip entry function 216 of the website interface 214 to create raw travel data in the raw travel data store 206. The user 102 may enter information related to scheduled or unscheduled travel providers or lodging providers, as described above. The user 102 may also enter information related to planned activities such as theater, dining or golf at a destination, which information may include location and reservation date and time.

In step 314, the travel data harvester 204 determines a polling interval to use in logging on to the one or more travel sources 108. The travel data harvester 204 may be scheduled to run at predetermined intervals (e.g. daily) and further scheduled to spread the logins evenly throughout the day. In other embodiments, the logins may be concentrated during off-peak hours. In yet other embodiments, the polling interval may be programmable or configurable by the user 102 or the travel source 108. It will be understood that other methods of determining polling intervals may be used in still other embodiments. In all embodiments, the travel data harvester 204 may log on to all the travel sources 108 for which the user 102 has stored credentials in the member data store 212, or may spread the logins over several polling intervals.

In yet other embodiments, the travel data harvester 204 may login to the one or more travel sources 108 when a user 102 logs on to the website interface 214. In still further other embodiments, the user 102 may issue a command from the website interface 214 that causes the travel data harvester 204 to log on.

If the travel data harvester 204 encounters an error while logging on to, or extracting data from, one of the travel sources 108, then in step 316 it will generate a system event message 264 to the notification engine 222. The message 264 includes the identity of the associated travel source 108 and a description of the problem encountered. The message 264 also includes the user as the recipient.

The travel data harvester 204 monitors its operation on a site by site basis for each of the users 102. It will generate an alert in step 316 if it is unable to return data due to firewall or third party site changes. It will also generate an alert if a site rejects the login credentials of the user 102 as invalid or expired.

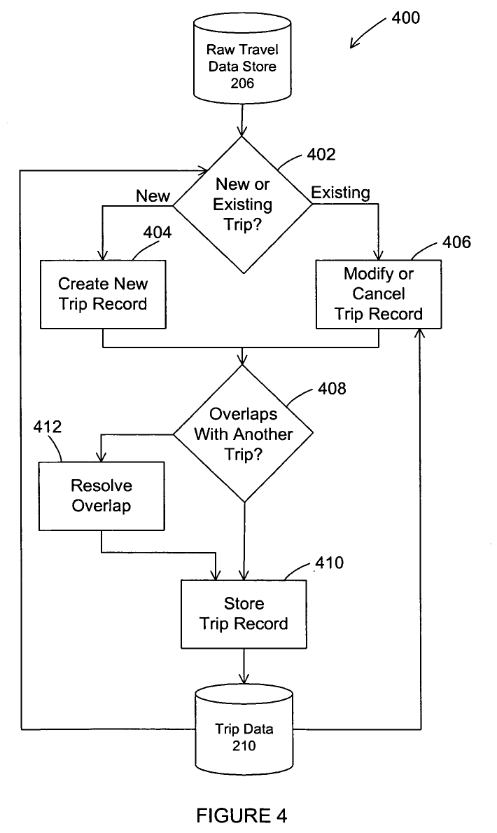

FIG. 4 presents a flow chart 400 of actions performed by the trip builder 208. In step 402, the trip builder 208 reads a raw travel data record from the raw travel data store 206 and, using information from the trip database 210, determines whether the record provides information about a component of a new trip or existing trip for the user 102. As described with reference to FIG. 3, the record may have been stored in the raw travel data store 206 by the travel data harvester 204. The record may also have been stored in the raw travel data store 206 by the user 102 via a manual trip entry function of the website interface 214.

If the raw travel data record read from the raw travel data store 206 relates to a component of a new trip, then the trip builder 208 creates a new trip record in step 404 and places information relating to the raw travel data record in the new trip record. If the raw travel data record relates to a component of an existing trip, then the trip builder 208 reads the existing trip record from the trip database 210 and updates it with information relating to the raw travel data record.

Whether the trip record is new or existing, in step 408 the trip builder 208 determines whether the trip record indicates an overlap with another trip for the user 102. If no overlap is detected, then the trip builder 208 stores the new or updated trip record in the trip database 210 in step 410. If an overlap is detected in step 408, then the trip builder 208 may handle the overlap in step 412 by sending a notification to the user 102 of the conflict and requesting that the user resolve the overlap. After the overlap is resolved in step 412, the trip builder 208 stores the new or updated trip record in the trip database 210 in step 410.

After storing into the trip database 210 in step 410, the trip builder 208 sends a system event message 264 to the notification engine 222 that includes an identifier of the new or updated trip, an indication of the change, and a suggestion to validate the trip and provide trip purpose. The message 264 further includes the user as the recipient of the resulting notification.

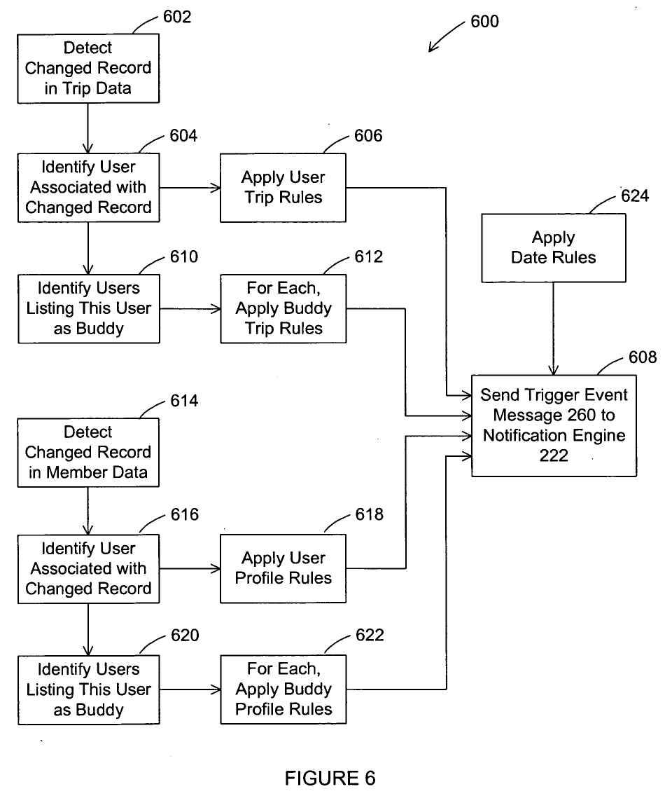

The user 102 may use the manual trip entry function 216 of the website interface 214 to create or update trip records in the trip database 210. Whether a trip record is created or updated by the trip builder 208 or the manual trip entry function 216, an associated change record is also stored in the trip database 210. The change record indicates to the rules engine 220 that the associated trip record should be processed in a manner that will be described with reference to FIG. 6.

The trip record stored in the trip database 210 consolidates information about different travel components (e.g., air, car, or hotel) that may have been booked separately or on different ones of the travel sources 108 into a single trip that has a destination and date range combination. The information in a trip record includes a destination that is translated into a city or other location and country, a trip start date, and a trip end date, if applicable. An example of a situation where a trip end date might not be applicable is a one-way trip. Other information in a trip record may include flight information, rental car information, hotel information, activity reservations, and/or details of individual components of the trip. It will be understood that in other embodiments, still other information may be stored in a trip record.

In creating or updating a trip record, the trip database 210 operates to recognize and accommodate the following situations, as well as others:
Multiple segment air bookings,
Unused air return trips,
One way air bookings,
Extended stay hotel reservations,
Open-jaw trips (into one destination and returning from a different origination), and
Car rentals with different pick up and drop off locations.

One example of creating a new trip record in step 404 arises when the trip builder 208 detects first and second flight bookings where the departure date/time of the second booking is more than eight hours after the arrival date/time of the first booking. In such a situation, the trip builder 208 creates a trip record having the arrival location of the first booking as the trip destination. For example, where a user 102 flies from Dallas to Denver, then stays overnight and then flies from Denver to Miami and stays for 5 days before returning home to Dallas via a direct flight. In this situation, the trip builder 208 creates two trip records. The first trip record has a destination of Denver and the second trip record has a destination of Miami.

Another example of creating a new trip record in step 404 arises from a combination of flight and hotel bookings. In this example, the user 102 has a flight booking from Dallas to Miami on a Monday with a return flight the following Monday. The user 102 also has a hotel booking in Key Largo for the intervening Thursday through Saturday. The trip builder 208 creates a first trip record to Miami for Monday through Thursday, a second trip record to Key Largo for Thursday through Saturday, and a third trip record to Miami for Saturday through Monday.

An example of modifying a trip record in step 406 arises where the hotel booking from the previous example in Key Largo is changed to Key West. In this situation, the trip builder 208 modifies the second trip record to a destination of Key West, rather than Key Largo. A first location and a second location may be considered the same location or destination if the locations are not separated by more than a predetermined distance—e.g., 100 miles.

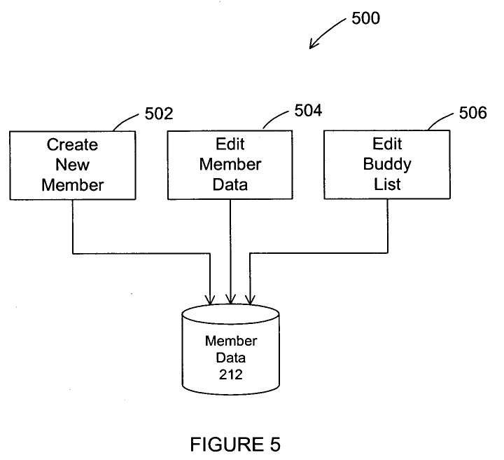

The user 102 may use user and buddy functions 218 of the website interface 214 to create and modify his/her member account in the member database 212. The user may perform these same functions from a third party website via the third party tools 228. FIG. 5 presents a flow chart 500 of actions performed by the user and buddy functions 218 or by the third party tools 228.

In step 502, the user 102 registers and creates a member record in the member database 212. In step 504, the user 102 edits the information in the member record. The information includes hometown and login information for one or more of the travel sources 108. In step 506, the user 102 creates and/or edits a list of contacts referred to as a buddy list. The information in the buddy list includes whether each contact is registered with the system 200. If the contact is not registered with the system, the information in the buddy list may include a preferred communication channel for the contact, such as e-mail, SMS, RSS, Twitter, or another channel, as well as an interval for such communications, such as daily, weekly, or monthly. It will be understood that other information relating to members and buddies may be stored in other embodiments.

Whether a member record is created or updated by the user and buddy functions 218 or the third party tools 228, an associated change record is also stored in the member database 212. The change record indicates to the rules engine 220 that the associated member record should be processed in a manner that will be described with reference to FIG. 6.

FIG. 6 presents a flow chart 600 of actions performed by the rules engine 220. In step 602, the rules engine 220 detects a change record in the trip database 210. The change record may include an indication of the changed information in the associated trip record of the trip database 210, or the rules engine 220 may detect which information has changed by comparing the associated trip record with a stored copy of its previous contents.

In step 604, the rules engine 220 identifies a user 102 associated with the trip record that the change record indicates has changed and in step 606 applies user trip rules to the changed trip record and one or more other records in the trip database 210 and/or the member database 212. If the criteria of one or more of the user trip rules are met in step 606, then the rules engine 220 sends a trigger event message 260 to the notification engine 222 in step 608.

An example of a user trip rule is the detection of a new trip created by a user. In response, the rules engine 220 generates a trigger event message 260 that includes the identity of the user and the destination and dates of the trip. The message further includes some or all of the user's list of buddies and friends as recipients of the resulting notification.

A further example of a user trip rule is the detection of a new trip created by the system 200 from information obtained from one or more travel sources 108. In response, the rules engine 220 generates a trigger event message 260 that includes the identity of the user and the destination and dates of the trip. The message further includes the user and some or all of the user's buddies as recipients of the resulting notification.

Another example of a user trip rule is the detection that the user and one or more buddies have trip records indicating the same destination and overlapping dates—i.e., that the user and buddies will be in the same place at the same time. In response, the rules engine 220 generates a trigger event message 260 that includes the identity of the user and the one or more buddies, the matching destination, and the dates of the overlap. The message further includes the user and the one or more buddies as recipients of the resulting notification.

Still another example of a user trip rule is the detection that the user will be visiting the hometown of one of his/her buddies, as stored in the second buddy's member record in the member database 212. In response, the rules engine 220 generates a trigger event message 260 that includes the identity of the user and the destination and dates of the trip. The message further includes the user and the buddy as recipients of the resulting notification.

Yet another example of a user trip rule is the detection that the user will be visiting a destination that one of the user's buddies has listed himself/herself a self-proclaimed “expert” in the buddy's member record in the member database 212. In response, the rules engine 220 generates a trigger event message 260 that includes the identity of the buddy, the matching destination, and the dates of the trip. The message further includes the user as the recipient of the resulting notification.

In step 610 of FIG. 6, regardless of the results in step 606, the rules engine 220 identifies any second users 102 whom the first user lists as a buddy. In step 612, for each of those second users, the rules engine 220 applies buddy trip rules to the changed trip record, the other user's member record in the member database 212, and one or more still other records in the trip database 210 and/or the member database 212. If the criteria of one or more of the buddy trip rules are met in step 612, then the rules engine 220 sends a trigger event message 260 to the notification engine 222 in step 608.

An example of a buddy trip rule is the detection that the first user and one or more other buddies of the second user have trip records indicating the same destination and overlapping dates—i.e., that the first user and the other buddies will be in the same place at the same time. In response, the rules engine 220 generates a trigger event message 260 that includes the identity of the user and the one or more other buddies, the matching destination, and the dates of the overlap. The message further includes the second user as the recipient of the resulting notification.

Another example of a buddy trip rule is the detection that the first user will be visiting the hometown of the second user, as stored in the second user's member record in the member database 212. In response, the rules engine 220 generates a trigger event message 260 that includes the identity of the user and the destination and dates of the trip. The message further includes the first user and the second user as recipients of the resulting notification.

In step 614 of FIG. 6, the rules engine 220 detects a change record in the member database 212. As described for a change record in the trip database 210, the rules engine 220 may detect changed information in the member record of the member database 212 that is associated with the change record from information included in the change record or from comparison of current and previous copies of the associated member record.

In step 616, the rules engine 220 identifies a user 102 associated with the member record that the change record indicates has changed and in step 618 applies user profile rules to the changed member record and one or more other records in the trip database 210 and/or the member database 212. If the criteria of one or more of the user profile rules are met in step 618, then the rules engine 220 sends a trigger event message 260 to the notification engine 222 in step 608.

An example of a user profile rule is the detection that the user has changed his/her member record in the member database 212. In response, the rules engine 220 generates a trigger event message 260 that includes the identity of the user and the changed member information. The message further includes the user and some or all of the user's list of buddies as recipients of the resulting notification.

Another example of a user profile rule is the detection that the user has added a person to his/her buddy list in the member database 212. In response, the rules engine 220 generates a trigger event message 260 that includes the identity of the user and the identity of the added buddy. The message further includes some or all of the user's list of buddies as recipients of the resulting notification.

Yet other examples of a user profile rule are the detection that the user has (i) invited a third party to register with the system 200, (ii) invited a second user to become a buddy, or (iii) sent a buddy a message. In response, the rules engine 220 generates a trigger event message 260 that includes the identity of the user, the identity of the buddy or third party, and the content of the invitation or message. The message 260 further includes the third party or buddy as the recipient of the resulting notification.

In step 620 of FIG. 6, regardless of the results in step 618, the rules engine 220 identifies any second users 102 whom the first user lists as a buddy. In step 622, for each of those second users, the rules engine 220 applies buddy profile rules to the changed member record, the other user's member record in the member database 212, and one or more still other records in the trip database 210 and/or the member database 212. If the criteria of one or more of the buddy profile rules are met in step 622, then the rules engine 220 sends a trigger event message 260 to the notification engine 222 in step 608.

An example of a buddy profile rule is the detection that the buddy in his/her member record in the member database 212 has changed his hometown or declared himself/herself an “expert” for a new location. In response, the rules engine 220 generates a trigger event message 260 that includes the identity of the buddy and the new hometown or new “expert” location. The message further includes the user as the recipient of the resulting notification.

In step 624, at a configurable interval, the rules engine 220 applies date rules to all records in the trip database 210 and the member database 212. If the criteria of one or more of the date rules are met in step 624, then the rules engine 220 sends a trigger event message 260 to the notification engine 222 in step 608.

An example of a date rule is detecting that the current date is the same as the departure or return date of a user's trip. In response, the rules engine 220 generates a trigger event message 260 that includes the identity of the user, the destination and dates of the trip, and a “bon voyage to (user)” or “welcome home to (user)” message, as appropriate. The message further includes the user and some or all of the user's list of buddies as recipients of the resulting notification.

Another example of a date rule is detecting that the current date is the same as the birthday of a user. In response, the rules engine 220 generates a trigger event message 260 that includes the identity of the user and a “happy birthday to (user)” message. The message further includes the user and some or all of the user's list of buddies as recipients of the resulting notification.

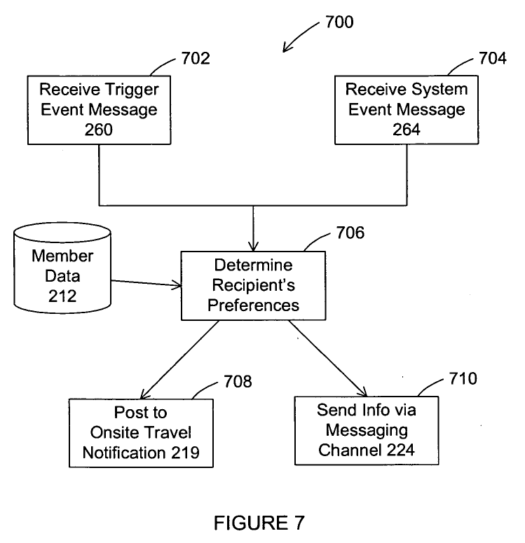

FIG. 7 presents a flow chart 700 of actions performed by the notification engine 222. In step 702, the notification engine 222 receives a trigger event message 260 from the rules engine 220. In step 704, the notification engine 222 receives a system event message 264 from the travel data harvester 204 or the trip builder 208. For either the trigger event message 260 or the system event message 264, in step 706 the notification engine 222 determines the notification preferences of the intended recipients as stored in the member database 212.

Where the recipient is a “friend” (i.e., a buddy who is not a registered member of the system 200), the recipient is not expected to log on to the website interface 214. Therefore, in step 710, the notification engine 222 sends the notification 262 to the recipient via a communication channel indicated by the user 102 when listing the “friend” in the user's member record of the member database 210.

Where the recipient is a “buddy” (i.e., a registered member of the system 200), the notification engine 222 sends the notification 262 to the recipient via the recipient's desired communication channels and at the recipient's desired intervals, as indicated in the recipient's member record in the member database 212. If indicated, in step 708, the notification engine posts the notification via data flow 261 to the online travel notification function 219 of the website interface 214 to be read by the recipient on his/her next login. In step 710, the notification engine 222 may additionally or alternatively send the notification 262 to the recipient via one or more of e-mail, SMS, MMS, RSS, Facebook, Twitter, or another communication channel, as indicated in the recipient's member record in the member database 210.

In step 710, rather than having the notification immediately sent, a recipient who is a registered user of the system 200 may choose to receive his/her notifications in a single daily or weekly email. Such grouped notifications may be sent at a desired time of day. For such recipients, the notification engine 222 will archive notifications and send them at the indicated intervals. Also in step 710, the notification engine 222 may additionally or alternatively send the notification 263 to the recipient via the third party tools 228.

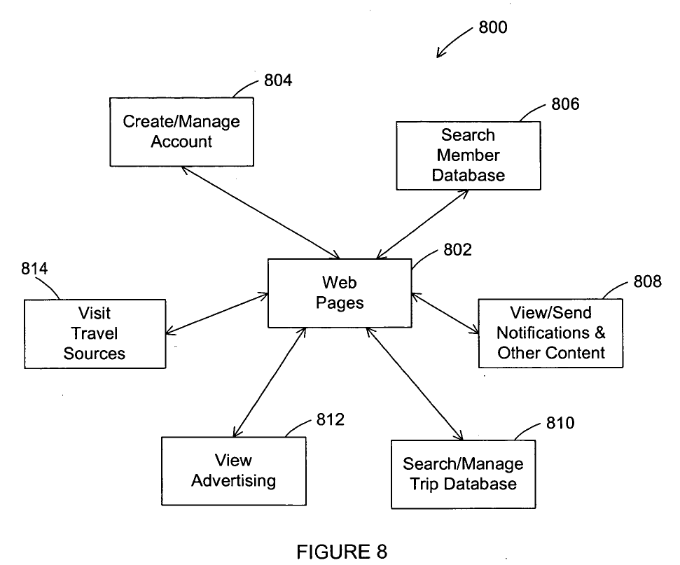

FIG. 8 presents a flow chart 800 of actions performed by the website interface 214. A collection of one or more web pages 802 provides a user 102 an interface to view and manage elements of the system 200. Functions 804, which provide some of the user and buddy functions 218, permit a user 102 to create an account, manage his/her notification and profile settings, and view or manage his/her buddy list. Using functions 806, the user 102 searches the member database for other users by name, location, trips taken, and/or friends-of-friends.

With functions 808, the user 102 can view notifications sent by the notification engine 222 from the system 200 or from other users. The user 102 can invite/delete friends to/from the buddy list or the service 200. The user 102 can share travel-related content—examples include blogs, journals, photos, videos, destination info, “things to do,” events, deals, top hotels, comparison shopping functionality. Such travel-related content may be shared both via notifications to buddies and through postings to third party sites via the third party tools 228. With functions 810, the user 102 can view and input his/her own trip information, view buddies' trip information, compare upcoming trips with his/her own and buddies, previous trips.

With functions 812, the user 102 can view general interest and targeted textual and/or graphical advertising chosen by the ads engine 230 (described in detail below), as well as respond to those ads by navigating to linked pages via the ads. Using functions 814, the user 102 can link to, modify, or remove links to third party travel websites. The user 102 may purchase new travel or add to existing trips from sites arrived at via ads or those navigated to using the functions 814.

While the user 102 is logged on to the website interface 214, the ads engine 230 reviews information from the trip database 210 and the member database 212, as well as information supplied by subscriber advertisers (via subscribing advertiser data database 234) to select ads to display in the website interface 214. The information used from the trip database 210 and the member database 212 may include gender, age, hometown, travel plans, and travel history of the user 102 and his/her buddies. When selecting a targeted ad to display to a user, the ads engine 230 provides an associated landing page or a direct link to the advertisers' website for use if the user 102 clicks on the ad.

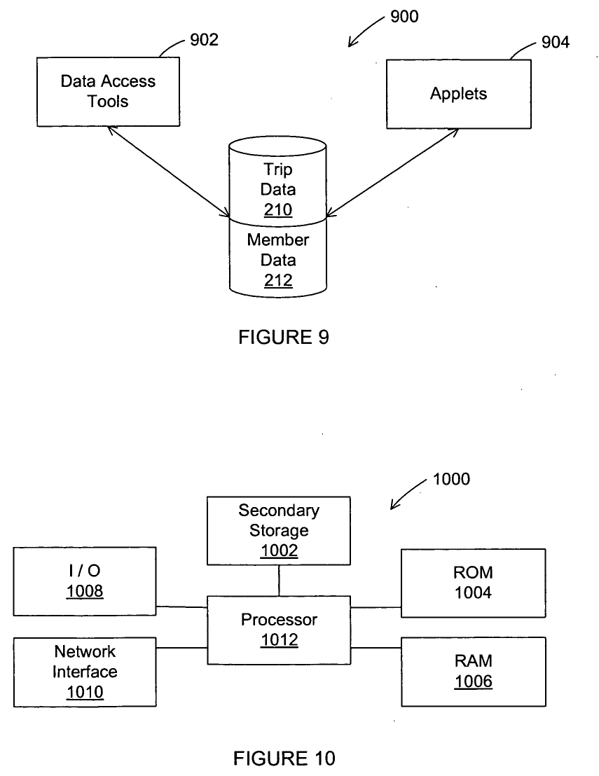

FIG. 9 presents a flow chart 900 of actions performed by the third party tools 228. Data access tools 902 allow trip database 210, member database 212, and other functionality of the system 200 to be used in controlled and restricted ways by third party websites and applications. Examples of such tools include third party developer API's, Web Services, HTTP POST, HTTP GET, and RSS feeds. Applets 904 allow travel monitoring and notification services of the system 200 via the notification engine 222 to be plugged into existing user bases and social networks of open platform websites. Examples of such websites include Facebook, myspace, Open Social, Friendster, Twitter, and LinkedIn.

Examples of data that a third party website or application might write into the member database 212 include personal trip photographs, videos, travel reviews, blog posts, and expense information. Examples of data that a third party website or application might write into the trip database 210 include city names, things to do, near-by attractions, destination content, and hotel reviews.

The elements of the disclosed system 200 may be implemented on one or more data processing systems that have sufficient processing power, memory resources, and network throughput capability to handle the necessary workload placed upon it/them. FIG. 10 illustrates such a data processing system, embodied in a typical, general-purpose computer system 1000. The general-purpose computer 1000 includes a processor 1012 (which may be referred to as a central processor unit or CPU) that is in communication with computer readable devices including secondary storage 1002, read only memory (ROM) 1004, and random access memory (RAM) 1006. The processor 1012 is also in communication with input/output (I/O) devices 1008, and network interface 1010. The processor 1012 may be implemented as one or more CPU chips.

The secondary storage 1002 is typically comprised of one or more disk drives, solid state (flash) drives, or tape drives and is used for non-volatile storage of data and as an over-flow data storage device if RAM 1006 is not large enough to hold all working data. The secondary storage 1002 may be used to store programs that are loaded into RAM 1006 when such programs are selected for execution. The ROM 1004 is used to store instructions and may store data that are read during program execution. The ROM 1004 is a non-volatile memory device that typically has a small memory capacity relative to the larger memory capacity of the secondary storage 1002. The RAM 1006 is used to store volatile data and perhaps to store instructions. Access to both the ROM 1004 and the RAM 1006 is typically faster than to the secondary storage 1002.

The I/O devices 1008 may include printers, video monitors, liquid crystal displays (LCDs), touch screen displays, keyboards, keypads, switches, dials, mice, personal digital assistants (PDAs), cell phones, track balls, voice recognizers, card readers, scanners, paper tape readers, or other well-known input devices. The network connectivity devices 1010 may include modems, modem banks, ethernet cards, universal serial bus (USB) interface cards, serial interfaces, token ring cards, fiber distributed data interface (FDDI) cards, wireless local area network (WLAN) cards, radio transceiver cards such as code division multiple access (CDMA) and/or global system for mobile communications (GSM) radio transceiver cards, and other devices. These network connectivity devices 1010 may enable the processor 61012 to communicate via communication link 1014 with an Internet or one or more intranets. With such a network connection, it is contemplated that the processor 1012 might receive information from the network, or might output information to the network in the course of performing the above-described functions.

Such information, which may include data or instructions to be executed using processor 1012 for example, may be received from and outputted to the network, for example, in the form of a computer data baseband signal or signal embodied in a carrier wave. The baseband signal or signal embodied in the carrier wave generated by the network connectivity devices 1010 may propagate in or on the surface of electrical conductors, in coaxial cables, in waveguides, in optical media, for example optical fiber, or in the air or free space.

The information contained in the baseband signal or signal embedded in the carrier wave may be ordered according to different sequences, as may be desirable for either processing or generating the information or transmitting or receiving the information. The baseband signal or signal embedded in the carrier wave, or other types of signals currently used or hereafter developed, referred to herein as the transmission medium, may be generated according to several methods well known to one skilled in the art.

The processor 1012 executes instructions, codes, computer programs, scripts that it accesses from hard disk, floppy disk, optical disk (these various disk based systems may all be considered secondary storage 1002), ROM 1004, RAM 1006, or the network connectivity devices 1010.

In some embodiments, various functions described above are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a flash drive, a compact disc (CD), a digital video disc (DVD), or any other type of memory.

It may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. The term “controller” means any device, system, or part thereof that controls at least one operation. A controller may be implemented in hardware, firmware, software, or some combination of at least two of the same. The functionality associated with any particular controller may be centralized or distributed, whether locally or remotely.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method, comprising:
accessing a first online data source, wherein the first online data source is accessed using a data processing system;
obtaining first travel information at the data processing system from the first online data source, the first travel information relating to a first reservation made by a first user;
storing the first travel information in the data processing system;
obtaining second travel information at the data processing system, the second travel information relating to a second reservation made by the first user;
storing the second travel information in the data processing system;
determining trip information in the data processing system from the first travel information and the second travel information, wherein the trip information relates to a trip planned by the first user and the trip is associated with the first reservation and the second reservation;
storing the trip information in the data processing system.

2. The method of claim 1, further comprising:
storing in the data processing system member information relating to the first user,
wherein accessing the first online data source comprises using the member information to access the website.

3. The method of claim 1, further comprising:
storing member information in the data processing system, wherein the member information relates to a second user associated with the first user; and
sending a message to the second user, wherein the message includes the trip information.

4. The method of claim 3, further comprising:
determining whether the trip information satisfies a predefined criterion; and
sending the message to the second user only if the information satisfies the predefined criterion.

5. The method of claim 1, further comprising:
storing member information in the data processing system, wherein the member information relates to a second user and a third user associated with the first user; and
sending a message to one of the second user and the third user, wherein the message includes the trip information and the one of the second user and the third user is selected based upon the member information.

6. The method of claim 1, further comprising:
the data processing system providing a website configured to enable the user to perform at least one of:
change the first travel information stored in the data processing system;
enter the second travel information; and
change the trip information stored in the data processing system.

7. The method of claim 1, further comprising:
accessing the first online data source using the data processing system;
obtaining third travel information from the first online data source relating to the first reservation; and
changing the trip information stored in the data processing system based upon the third travel information.

8. The method of claim 1, wherein obtaining second travel information comprises one of receiving an email, accessing a second online data source, and receiving an HTTP POST method call.

9. The method of claim 1, further comprising displaying the trip information on a website.

10. The method of claim 1, further comprising sending the trip information to a publish/subscribe service.

11. The method of claim 1, wherein accessing a first online data source is performed repeatedly at a programmable interval.

12. The method of claim 1, wherein the trip information includes a destination and a date range.

13. A method, comprising:
storing in the data processing system member information relating to a first user and a second user, wherein the first user and the second user are associated with a third user;
obtaining first trip information in the data processing system, the first trip information relating to a first trip planned by the first user, wherein the first trip information includes a first destination and a first date range;
obtaining second trip information in the data processing system, the second trip information relating to a second trip planned by the second user, wherein the second trip information includes a second destination and a second date range;
responsive to detecting in the data processing system that the first destination is the same as the second destination and the first date range overlaps the second date range, communicating from the data processing system to the third user an identity of the first user, an identify of the second user, the first destination, and one or more dates within the overlap of the first date range and the second date range.

14. A system, comprising:
a computer readable storage medium; and
a processor coupled to the computer readable storage medium,
wherein the processor is operable to read instructions from the computer readable storage medium to:
access a first online data source;
obtain first travel information from the first online data source, the first travel information relating to a first reservation made by a first user;
store the first travel information in the computer readable storage medium;
obtain second travel information relating to a second reservation made by the first user;
store the second travel information in the computer readable storage medium;
determine trip information from the first travel information and the second travel information, wherein the trip information relates to a trip planned by the first user and the trip is associated with the first reservation and the second reservation; and
store the trip information in the computer readable storage medium.

15. The system of claim 14, wherein the processor is further operable to read instructions from the computer readable storage medium to:
store member information in the computer readable storage medium, wherein the member information relates to a second user associated with the first user;
determine whether the trip information satisfies a predefined criterion; and
send a message to the second user only if the information satisfies the predefined criterion, wherein the message includes the trip information.

16. The system of claim 14, wherein the processor is further operable to read instructions from the computer readable storage medium to:
store member information in the computer readable storage medium, wherein the member information relates to a second user and a third user associated with the first user;
select one of the second user and the third user based upon the member information; and
send a message to the selected one of the second user and the third user, wherein the message includes the trip information.

17. The system of claim 14, wherein the processor is further operable to read instructions from the computer readable storage medium to:
provide a website configured to enable the user to perform at least one of:
change the first travel information stored in the computer readable storage medium;
enter the second travel information; and
change the trip information stored in the computer readable storage medium.

18. The system of claim 14, wherein the processor is further operable to read instructions from the computer readable storage medium to:
access the first online data source;
obtain third travel information from the first online data source relating to the first reservation; and
change the trip information stored in the computer readable storage medium based upon the third travel information.

19. The system of claim 14, wherein the processor is further operable to read instructions from the computer readable storage medium to:
provide a website; and
display the trip information on the website.

20. A computer program product tangibly embodied in a computer readable storage medium, comprising:
instructions for accessing a first online data source;
instructions for obtaining first travel information from the first online data source, the first travel information relating to a first reservation made by a first user;
instructions for storing the first travel information;
instructions for obtaining second travel information, the second travel information relating to a second reservation made by the first user;
instructions for storing the second travel information;
instructions for determining trip information from the first travel information and the second travel information, wherein the trip information relates to a trip planned by the first user and the trip is associated with the first reservation and the second reservation; and
instructions for storing the trip information.

21. The computer program product of claim 20, further comprising:
instructions for storing member information, wherein the member information relates to a second user associated with the first user;
instructions for determining whether the trip information satisfies a predefined criterion; and
instructions for sending a message to the second user only if the information satisfies the predefined criterion, wherein the message includes the trip information.

22. The computer program product of claim 20, further comprising:
instructions for storing member information in the computer readable storage medium, wherein the member information relates to a second user and a third user associated with the first user;
instructions for selecting one of the second user and the third user based upon the member information; and
instructions for sending a message to the selected one of the second user and the third user, wherein the message includes the trip information.

23. The computer program product of claim 20, further comprising:
instructions for providing a website configured to enable the user to perform at least one of:
change the stored first travel information;
enter the second travel information; and
change the stored trip information.

24. The computer program product of claim 20, further comprising:
accessing the first online data source;
obtaining third travel information from the first online data source relating to the first reservation; and
changing the stored trip information based upon the third travel information.

25. The computer program product of claim 20, further comprising:
instructions for providing a website; and
instructions for displaying the trip information on the website.

26. The computer program product of claim 20, further comprising:
instructions for sending the trip information to a publish/subscribe service.

27. The computer program product of claim 20, further comprising:
instructions for accessing the first online data source repeatedly at a programmable interval.
